(19) United States
(12) Patent Application Publication
(10) Pub. No.: US 2013/0057462 A1
(43) Pub. Date: Mar. 7, 2013

(54) LED Driving Circuit, Liquid Crystal Display Device and Driving Method Thereof

(71) Applicants: Xiang Yang, Shenzhen (CN); Dongsheng Guo, Shenzhen (CN)

(72) Inventors: Xiang Yang, Shenzhen (CN); Dongsheng Guo, Shenzhen (CN)

(21) Appl. No.: 13/263,741

(22) PCT Filed: Sep. 9, 2011
(86) PCT No.: PCT/CN11/79536

§ 371 Date: Oct. 8, 2011

(30) Foreign Application Priority Data
Sep. 6, 2011 (CN) 201110262761.0

(51) Int. Cl. G09G 3/36; H05B 37/02

(52) U.S. Cl. 345/102; 315/186

(57) ABSTRACT

The present invention discloses a LED driving circuit, a LCD device and a driving method thereof wherein said LED driving circuit comprises LED strings, a power supply module for supplying power for the LED strings under the control of the on/off signal, and an output capacitor which is in parallel connection with the LED strings; and said LED driving circuit also comprises a discharge module which is in parallel connection with the output capacitor and operates when the on/off signal is at low level. Because the output capacitor is in parallel connection with a controllable discharge module, the discharge module can be connected at the interval between ON and OFF to discharge the output capacitor. The present invention solves the problem of extra charges remaining in the capacitor so that the LED can not be turned on twice in ON operation; meanwhile, the consumption of the circuit under normal operation is not affected.

### TECHNICAL FIELD

The present invention relates to the field of liquid crystal display (LCD)s, particularly to a LED driving circuit, a LCD device and a driving method thereof.

### BACKGROUND

The LED driving circuit in the prior art is usually as shown in FIG. 1. When the ON/OFF signal performs ON operation and OFF operation at short intervals, the charges of the output capacitor are not discharged in time when performing OFF operation immediately after ON operation. Thus, the charges will be filled into the LEDs in the next ON operation, and then filled into the normal LED driver. Because the LED driving circuit always has certain delay time in the ON operation each time, the LED lights will come on twice, causing blinking.

To solve the aforementioned problems, there are usually two procedures as follows.

1. Accelerating the ON speed so that the eyes of a person can not judge whether the LED lights come on twice. But accelerating the ON speed will affect the stabilization of the system loop and the problem of the charges of the capacitor is not directly solved.

2. Directly adding a discharge resistor at the capacitor end to discharge the capacitor. But directly adding a discharge resistor is equivalent to adding a load, which consume the circuit power continuously, causing unnecessary consumption. Additionally once the resistor is damaged, the output end will short circuit which lead to safety issues.

### SUMMARY

The aim of the present invention is to provide a LED driving circuit, a LCD device and a driving method thereof which can solve the problem of LED blinking in ON/OFF operation in a stable, reliable and low-consumption mode.

The purpose of the present invention is achieved by the following technical schemes.

A LED driving circuit comprises LED strings, a power supply module for supplying power for the LED strings under the control of the on/off signal, and an output capacitor which is in parallel connection with the LED strings; and said LED driving circuit also comprises a discharge module which is in parallel connection with the output capacitor and operates when the on/off signal is at low level.

Preferably, said discharge module comprises a loading resistor, and a controllable switch which is in series connection with the loading resistor, wherein the control end of said controllable switch is connected to said on/off signal. This is one embodiment of the discharge module.

Preferably, said discharge module is in series connection with a diode for preventing reverse conduction. This prevents the discharge of the power supply module and the output capacitor to the loading resistor, which is caused by turning on said controllable switch by misoperation during ON operation.

Preferably, said LED strings are in series connection with a PWM dimming module for regulating the LED brightness, and said discharge module operates when the on/off signal or the control signal of the PWM dimming module is at low level. This is one embodiment of the LED driving circuit with dimming function.

Preferably, said discharge module comprises a loading resistor and a controllable switch which is in series connection with the loading resistor, wherein said on/off signal and the control signal of the PWM dimming module is connected to the control end of the controllable switch by the OR gate. Through the control of the OR gate, when either the on/off signal or the control signal of the PWM dimming module is at low level, the controllable switch is turned on, and the charges of the output capacitor are discharged by the loading resistor and the diode. Thus, the extra charges of the output capacitor are discharged in the OFF operation. Therefore, the problem of blinking caused by discharging the charges of the output capacitor to the LEDs in the next ON operation can be avoided.

A LCD device comprises the aforementioned LED driving circuit.

A LED driving method comprises the following steps:

Connecting the discharge module which is in parallel connection with the output capacitor when the on/off signal for controlling the LED strings is at low level, so that the output capacitor which is in parallel connection with the LED strings discharges to said discharge module; and

Disconnecting the discharge module which is in parallel connection with the output capacitor when the on/off signal for controlling the LED strings is at high level, so that the output capacitor which is in parallel connection with the LED strings normally supplies power for said LED strings.

Preferably, connecting the discharge module which is in parallel connection with the output capacitor when the on/off signal for controlling the LED strings or the control signal of the PWM dimming module is at low level, so that the output capacitor which is in parallel connection with the LIED strings discharges to said discharge module; and

Disconnecting the discharge module which is in parallel connection with the output capacitor only when both said on/off signal for controlling the LED strings and said control signal of the PWM dimming module are at high level, so that said power supply module and the output capacitor which is in parallel connection with the LED strings supply power for said LED strings.

The present invention is stable and reliable because the output capacitor is in parallel connection with a controllable discharge module so that the discharge module can be connected at the interval between ON and OFF to discharge the output capacitor. The charges of the output capacitor have been exhausted already before the next ON operation. Thus, the LEDs can not be lightened by the output capacitor so that the problem of LED blinking in the ON operation is fundamentally solved; and the normal operation of other circuits are not affected because the discharge module operates independent of the system loop; the discharge module is only used at the interval between ON and OFF, and is in the cut-off state after on operation, so that the consumption is small. In summary, the present invention solves the problem of the extra charges remaining in the capacitor so that the LEDs will not be turned on twice in ON operation; meanwhile, the consumption of the circuit under normal operation is not affected.

### BRIEF DESCRIPTION OF FIGURES

FIG. 1 is the block diagram of the LED driving circuit in the prior art;

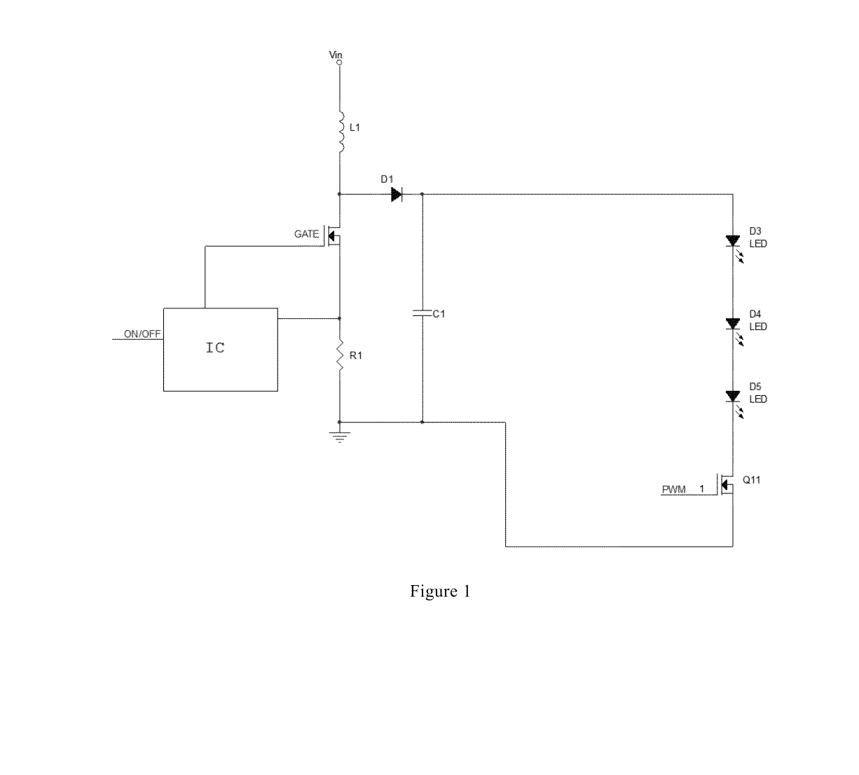

FIG. 2 is the block diagram of the LED driving circuit of the present invention;

Wherein: 1. power supply module; 2. LED string; 3, discharge module.

### DETAILED DESCRIPTION

The present invention will further be described in detail in accordance with the figures and the preferred embodiments.

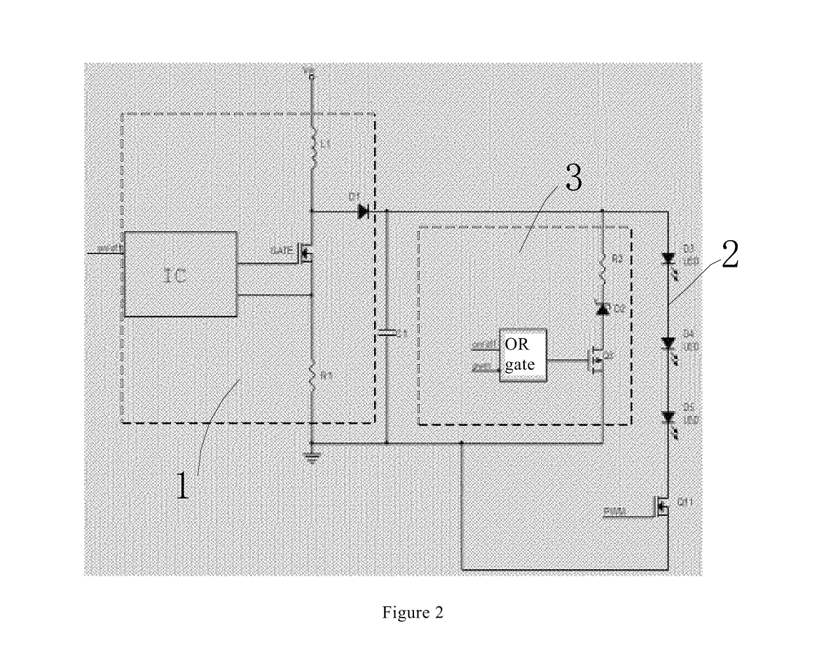

As shown in FIG. 2, the LED driving circuit of the LCD device comprises LED strings 2, power supply module 1 for supplying power to the LED strings under the control of the on/off signal, and an output capacitor C1 which is in parallel connection with the LED string 2; and said LED driving circuit also comprises discharge module 3 which is in parallel connection with the output capacitor C1, wherein said discharge module 3 operates when the on/off signal is at low level. The invention will further be described in detail in accordance with the embodiments.

### Embodiment 1

Said discharge module 3 comprises a loading resistor and a controllable switch Q3 (such as MOS switch) which is in series connection with the loading resistor, wherein the control end of said controllable switch Q3 is connected to said on/off signal. The extra charges of the capacitor are discharged by said controllable switch Q3 when the current of the LED is closed, so that the problem of LED blinking caused by the capacitor charges can be solved. Preferably, said discharge module 3 is in series connection with a diode for preventing reverse conduction so that the discharge of the power supply module 1 and the output capacitor C1 to the loading resistor R2, which is caused by turning on said controllable switch Q3 by misoperation during ON operation, can be avoided.

When the on/off signal is at low level, the controllable switch Q3 is turned on, and the charges of the output capacitor C1 are discharged by the loading resistor R2 and the diode D2. Thus, the extra charges of the output capacitor C1 are discharged in OFF operation. Therefore, the problem of blinking caused by discharging the charges of the output capacitor C1 to the LEDs in the next ON operation can be avoided.

### Embodiment 2

This is one embodiment of the LED driving circuit with dimming function.

Said LED strings 2 are in series connection with a PWM dimming module for regulating the LED brightness, and said discharge module 3 operates when either the on/off signal or the control signal of the PWM dimming module is at low level. Thus, under the condition that the LED strings 2 do not operate, the extra charges of the output capacitor C1 can be discharged. This solves the problem of blinking caused by lightening the LEDs twice, when the LEDs are lightened by the extra charges of the output capacitor C1 after the LED strings 2 are conducted and before the LED strings 2 are supplied.

In addition, said discharge module 3 comprises a loading resistor R2 and a controllable switch Q3 (such as MOS switch) which is in series connection with the loading resistor R2, wherein said on/off signal and the control signal of the PWM dimming module is connected to the control end of the controllable switch Q3 by the OR gate; the control end of said controllable switch Q3 is connected to said on/off signal; and the extra charges of the capacitor are discharged by said controllable switch Q3 when the current of the LED is closed. This solves the problem of LED blinking caused by the capacitor charges. Said discharge module 3 is in series connection with a diode D2 for preventing reverse conduction, so that the discharge of the power supply module 1 and the output capacitor C1 to the loading resistor R2, which is caused by turning on said controllable switch Q3 by misoperation during ON operation, can be avoided.

Through the control of the OR gate, when either the on/off signal or the control signal of the PWM dimming module is at low level, the controllable switch Q3 is turned on; and the charges of the output capacitor C1 are discharged by the loading resistor R2 and the diode D2. Thus, the extra charges of the output capacitor C1 are discharged in the OFF operation. Therefore, this solves the problem of blinking caused by discharging the charges of the output capacitor C1 to the LEDs in the next ON operation.

The LED driving circuit of the aforementioned LCD device is in parallel connection with a controllable discharge module 3 at both ends of said output capacitor C1, and then said on/off signal is connected to the control end of said discharge module 3; the LED driving method thereof comprises the following steps.

Connecting the discharge module 3 which is in parallel connection with the output capacitor when the on/off signal for controlling the LED strings is at low level, so that the output capacitor C1 which is in parallel connection with the LED strings discharges to said discharge module 3; and

Disconnecting the discharge module 3 which is in parallel connection with the output capacitor when the on/off signal for controlling the LED strings is at high level, so that said power supply module 1 and the output capacitor C1 which is in parallel connection with the LED strings normally supply power for said LED strings 2.

For the LED driving circuit with dimming function, coupling the control end of said discharge module 3 with said control signal of the PWM dimming module, so that said control signal of the PWM dimming module and said on/off signal is connected to the control end of said discharge module 3 by the OR gate; connecting the discharge module 3 which is in parallel connection with the output capacitor C1 when the on/off signal for controlling the LED strings 2 or the control signal of the PWM dimming module is at low level, so that the output capacitor C1 which is in parallel connection with the LED strings 2 discharges to said discharge module 3; and

Disconnecting the discharge module 3 which is in parallel connection with the output capacitor C1 only when both said on/off signal for controlling the LED strings 2 and said control signal of the PWM dimming module are at high level, so that said power supply module 1 and the output capacitor C1 which is in parallel connection with the LED strings 2 supply power for said LED strings 2.

In the present invention the output capacitor C1 is in parallel connection with a controllable discharge module 3, so that the discharge module 3 can be connected at the interval between ON and OFF to discharge to the output capacitor C1; the charges of the output capacitor C1 have been exhausted already before the next ON operation; thus, the LEDs can not be lightened by the output capacitor C1, so that the problem of LED blinking in the ON operation is fundamentally solved; the normal operation of other circuits can not be affected because the discharge module 3 operates independent of the system loop in a stable and reliable manner; the discharge module 3 is only used at the interval between ON and OFF, and is in the cut-off state after ON operation, so that the consumption is very small. In summary, the present invention solves the problem of extra charges remaining in the capacitor, so that the LEDs will not be turned on twice in ON operation; meanwhile, the consumption of the circuit under normal operation is not affected.

The present invention is described in detail in accordance with the above contents with the specific preferred embodiments. However, this invention is not limited to the specific embodiments. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. A LED driving circuit, comprising: LED strings, a power supply module for supplying power for the LED strings, and an output capacitor which is in parallel connection with the LED strings; and said LED driving circuit also comprises a discharge module which is in parallel connection with the output capacitor and operates when the ON/OFF signal is at low level.

2. The LED driving circuit of claim 1, wherein said discharge module comprises a loading resistor, and a controllable switch which is in series connection with the loading resistor; and the control end of said controllable switch is connected to said ON/OFF signal.

3. The LED driving circuit of claim 2, wherein said discharge module is in series connection with a diode for preventing reverse conduction.

4. The LED driving circuit of claim 1, wherein said LED strings are in series connection with a PWM dimming module for regulating the LED brightness, and said discharge module operates when the ON/OFF signal or the control signal of the PWM dimming module is at low level.

5. The LED driving circuit of claim 4, wherein said discharge module comprises a loading resistor and a controllable switch which is in series connection with the loading resistor; and said ON/OFF signal and the control signal of the PWM dimming module is connected to the control end of the controllable switch by the OR gate.

6. The LED driving circuit of claim 5, wherein said discharge module is in series connection with a diode for preventing reverse conduction.

7. A liquid crystal display (LCD) device, comprising: a LED driving circuit of claim 1, said LED driving circuit comprises LED strings, a power supply module for supplying power for the LED strings, and an output capacitor which is in parallel connection with the LED strings; and said LED driving circuit also comprises a discharge module which is in parallel connection with the output capacitor and operates when the ON/OFF signal is at low level.

8. The LCD device of claim 7, wherein said discharge module comprises a loading resistor and a controllable switch which is in series connection with the loading resistor; and the control end of said controllable switch is connected to said ON/OFF signal.

9. The LCD device of claim 8, wherein said discharge module is in series connection with a diode for preventing reverse conduction.

10. The LCD device of claim 7, wherein said LED strings are in series connection with a PWM dimming module for regulating the LED brightness, and said discharge module operates when the ON/OFF signal or the control signal of the PWM dimming module is at low level.

11. The LCD device of claim 10, wherein said discharge module comprises a loading resistor, and a controllable switch which is in series connection with the loading resistor; and said ON/OFF signal and the control signal of the PWM dimming module is connected to the control end of the controllable switch by the OR gate.

12. The LCD device of claim 11, wherein said discharge module is in series connection with a diode for preventing reverse conduction.

13. A LED driving method, comprising the following steps:
connecting the discharge module which is in parallel connection with the output capacitor when the on/off signal for controlling the LED strings is at low level, so that the output capacitor which is in parallel connection with the LED strings discharges to said discharge module; and
disconnecting the discharge module which is in parallel connection with the output capacitor when the on/off signal for controlling the LED strings is at high level, so that the output capacitor which is in parallel connection with the LED strings normally supplies power for said LED strings.

14. The driving method of claim 13, wherein the method comprises the following steps:
connecting the discharge module which is in parallel connection with the output capacitor when the on/off signal for controlling the LED strings or the control signal of the PWM dimming module is at low level, so that the output capacitor which is in parallel connection with the LED strings discharges to said discharge module; and
disconnecting the discharge module which is in parallel connection with the output capacitor only when both said on/off signal for controlling the LED strings and said control signal of the PWM dimming module are at high level, so that said power supply module and the output capacitor which is in parallel connection with the LED strings supply power for said LED strings.
